(19) United States
(12) Patent Application Publication
(10) Pub. No.: US 2016/0178084 A1
(43) Pub. Date: Jun. 23, 2016

(54) Pressure-Setting Regulator

(71) Applicant: Black & Decker Inc., Newark, DE (US)

(72) Inventors: Gary D. White, Medina, TN (US); Christina Wilson, Jackson, TN (US)

(73) Assignee: Black & Decker Inc., Newark, DE (US)

(21) Appl. No.: 14/967,319

(22) Filed: Dec. 13, 2015

Related U.S. Application Data
(60) Provisional application No. 62/093,702, filed on Dec. 18, 2014.

(51) Int. Cl. F16K 31/50; F04B 35/01; F04B 53/14; F04B 39/10; F04B 49/08; F04B 49/22; F16K 37/00; F04B 39/12

(52) U.S. Cl. CPC F16K 31/50; F16K 37/0016; F04B 35/01; F04B 39/12; F04B 39/1066; F04B 49/08; F04B 49/22; F04B 53/14

(57) ABSTRACT

An air compressor having a pressure-setting regulator for setting a regulator outlet pressure without a separate pressure gauge. A pressure controlling regulator knob can be rotated to set and control the regulator outlet pressure selected from a scale of set outlet pressures. The pressure control system can utilize a single-turn pressure control knob which can be used to select any pressure from a range of outlet pressures which can be produced by the regulator a partial or full rotation of the regulator knob. A compressor can use the positive control pressure regulation system, be free of an outlet pressure gauge, and allow a user to select an outlet pressure from a range of outlet pressures by rotating the single-turn regulator knob to select a set outlet pressure from the scale of set outlet pressures.

### INCORPORATION BY REFERENCE

This patent application is a nonprovisional application of copending U.S. provisional application 62/093,702, and incorporates by reference in its entirety copending U.S. provisional patent application 62/093,702 entitled “Pressure-Setting Regulator” filed Dec. 18, 2014.

This patent application also incorporates by reference in its entirety U.S. Pat. No. 8,899,378 entitled “Compressor Intake Muffler And Filter” issued Dec. 2, 2014.

### FIELD OF THE INVENTION

The invention relates to a pressure regulator.

### BACKGROUND OF THE INVENTION

Manually setting the outlet pressure of a pressure regulator is an inefficient, clumsy and empirical process that requires a feedback system in which an operator visually monitors an outlet pressure gauge and adjusts and tweaks the regulator pressure drop until a final outlet pressure is eventually achieved. This approach is time consuming, inaccurate, and allows for an operator to overshoot or undershoot a desired outlet pressure during the process. Such error can cause operational difficulties, as well as preventing operation at the outlet pressure desired. A strong need exists for a new control system for manually setting the outlet pressure of pressure regulators.

### SUMMARY OF THE INVENTION

An embodiment of the present invention is directed to an air compressor that eliminates the regulator pressure gauge and allows the regulator to manually be set to a predetermined pressure.

In an embodiment, a pressure regulator can have a scale indicating a number of outlet pressures which can be set as a selected outlet pressure of a gas exiting the pressure regulator. A regulator knob can be adapted to be rotated manually to a selected outlet pressure chosen from the number of outlet pressures. A regulator spring can be used that at least in part controls a valve that regulates a flow of the gas. The regulator knob can be adapted to change a spring compression of the regulator spring when the regulator knob is manually rotated to set the selected outlet pressure of the gas.

In an embodiment, rotation of the regulator knob to the selected outlet pressure, as well as setting a selected outlet pressure, can be free of a feedback control mechanism. The selected outlet pressure can be set by the regulator knob to a value selected on the scale and the pressure regulator can be configured to produce an outlet pressure free of reference to an outlet pressure gauge.

The scale can be of a variety of configurations. For example, the scale can be configured to be generally coaxial with the circumference of the regulator knob. In an embodiment, the scale can be configured to be generally coaxial with the circumference of the regulator knob and can indicate a plurality of outlet pressures which can be selected and which have one or more of the plurality of outlet pressures in a range of from 25 psig to 250 psig, or higher.

The regulator knob can also have of a variety of designs. In one embodiment, the regulator knob can have single-turn coarse grooves which slideably engage single-turn coarse threads which project from a portion of a regulator body, such as a control cylinder. Optionally, the regulator knob can have an indicium which can be aligned with a portion of the scale to set the selected outlet pressure. In an embodiment, the indicium can be an arrow, such as a set point arrow, which can be pointed to a pressure indicated by the scale to set a selected outlet pressure.

The rotation of the regulator knob and the indication of its position can have a variety of mechanisms, in an embodiment the regulator knob can be ratcheted when rotated to cause an alignment of a portion of the regulator knob to a portion of the scale to set the selected outlet pressure.

In an embodiment, a pressure control system can have the pressure regulator which can have a regulator knob which can be rotated to control an outlet pressure of a gas exiting the pressure regulator. The pressure control system can also have the scale configured proximate to the regulator knob and indicating a plurality of outlet pressure values one of which can be selected as an outlet set pressure; an indicium mounted on and moved by the regulator knob, the indicium proximate to an outlet pressure value that is selected as an outlet set pressure. In an embodiment, the outlet set pressure can be selected by rotating the regulator knob to control the outlet pressure of the gas exiting the regulator at a desired outlet set pressure.

In an embodiment, the pressure control system can have a control cylinder can have a single-turn course thread projecting from a portion of a regulator body. The single-turn course thread can be configured to slideably engage the regulator knob. The pressure control system can use a regulator knob which is a single-turn regulator knob.

The pressure control system can control the outlet pressure to within 15 percent, or 10 percent, or closer, of an outlet set pressure when the regulator knob remains in a fixed position corresponding to a selected outlet pressure. In an embodiment, the pressure control system can be configured to indicate an outlet pressure midpoint when the regulator knob is rotated to a point that is located at about one-half of its rotational range.

A compressor can have the pressure-setting regulator and/or the pressure control system which uses the pressure-setting regulator. In an embodiment, a compressor for producing a compressed gas can have the pressure regulator, a scale indicating a plurality of outlet pressures which can be set as a selected outlet pressure of a gas exiting the regulator and a regulator knob adapted to be manually rotated to set the selected outlet pressure from the plurality of outlet pressures of the scale. A regulator spring can at least in part control a valve that regulates a flow of the gas of the pressure-setting regulator. The regulator knob can be adapted to change a spring compression of the regulator spring when the regulator knob is manually rotated to set the selected outlet pressure of the gas. In an embodiment, the scale can be configured proximate to the regulator knob.

In an embodiment, a positive control method of pressure regulation can use the pressure-setting regulator. A method of controlling the regulator outlet pressure can have the steps of: providing a regulator having a single-turn regulator knob which has an indicium adapted to indicated a portion of the scale; providing the scale configured proximate to the single-turn regulator knob and having a plurality of outlet pressures; rotating the single-turn regulator knob such that the indicium indicates an outlet pressure which is an outlet pressure set point; and in which the rotating of the single-turn regulator knob changes the pressure exerted by a regulator spring which changes the differential pressure of the regulator to change the outlet pressure. In an embodiment, the method of controlling regulator outlet pressure can control the controlling the outlet pressure within 20 percent of the outlet pressure set point.

In an embodiment, the pressure-setting regulator can be set to an outlet pressure by rotating the regulator knob such that the indicium, such as the set point arrow, is proximate to a selected outlet pressure. In an embodiment, the regulator knob can be calibrated to position the indicium, such as an arrow or other mark, such that it is configured at the mid-range of the single-turn regulator knob rotational range. In another embodiment, the pressure-setting regulator can be calibrated to achieve a minimum variance in the outlet pressure when the indicium is at a position within 45 degrees of the rotational mid-point of the regulator knob.

### BRIEF DESCRIPTION OF THE DRAWINGS

The present invention in its several aspects and embodiments solves the problems discussed above and significantly advances the technology of pressure regulators. The present invention can become more fully understood from the detailed description and the accompanying drawings, wherein:

FIG. 1 shows an existing air compressor employing a feedback control system having a regulator and an outlet pressure gauge;

FIG. 2 shows a perspective view of a compressor assembly having a pressure-setting regulator;

FIG. 3 shows a perspective view of the mechanical design of the compressor assembly having the pressure-setting regulator without the housing;

FIG. 4 shows a pump-side view of the mechanical design of the compressor assembly having the pressure-setting regulator without the housing;

FIG. 5A shows a control cylinder with a fine pitch thread;

FIG. 5B shows the control cylinder with a coarse pitch thread;

FIG. 6A shows a regulator knob with grooves corresponding to the fine pitch thread;

FIG. 6B shows the regulator knob with grooves corresponding to the coarse pitch thread;

FIG. 7 shows a sectional view of the pressure-setting regulator;

FIG. 8 shows a dashboard having an inlet pressure gauge and the pressure-setting regulator with an example scale of outlet set pressure options;

FIG. 9 shows a dashboard having an inlet pressure gauge and a multi-turn configuration of the pressure-setting regulator;

FIG. 10A shows the knob bearing an indicium at a first position;

FIG. 10B shows the knob bearing an indicium being rotated to a second position;

FIG. 10C shows the knob bearing an indicium at a third position;

FIG. 10D shows the knob bearing an indicium being rotated to a fourth position;

FIG. 11A shows a sectional view of the pressure-setting regulator in a closed configuration;

FIG. 11B shows a sectional view of the pressure-setting regulator having the knob rotatable to increase and decrease the pressure of an outlet gas stream; and

FIG. 11C shows a sectional view of the pressure-setting regulator having the knob rotated to a set outlet pressure and regulating the flow of an outlet gas stream.

Herein, like reference numbers in one figure refer to like reference numbers in another figure.

### DETAILED DESCRIPTION OF THE INVENTION

The invention relates to the many and varied embodiments of a positive control regulator, pressure regulation system and to methods for regulating outlet gas pressure from a compressor. The pressure regulation system can be used with a compressor assembly which can compress air, or a gas, or gas mixtures. The compressor can compress one or more gases, inert gases, or mixed gas compositions.

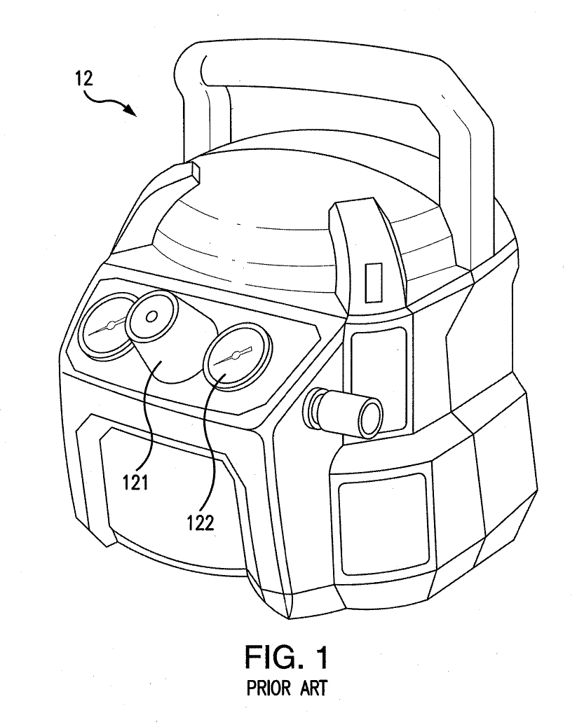

FIG. 1 shows an existing air compressor employing a feedback control system having a regulator and an outlet pressure gauge. As shown in FIG. 1, existing air compressors have a manifold including a regulator for increasing or decreasing the pressure output to a connected power tool. The regulator can be in the form of an old-style regulator knob 121 that is connected to a pressure regulator valve that opens and closes to admit and obstruct, respectively, the flow of pressurized air into the power tool. The regulator is connected to a regulator outlet pressure gauge 122 that measures the regulator pressure and provides an indication of the measurement in a form such as a dial that can be read by the user. When the regulator knob is turned, there is a delay between setting the regulator pressure and the pressure gauge readout until the pressure in the system catches up to the regulator pressure or decreases to the regulator pressure selected by the user. In addition, it is necessary for the user to perform incremental regulator knob rotations, clockwise and counterclockwise, in order to adjust the regulator until the regulator outlet pressure gauge 122 reads the desired pressure.

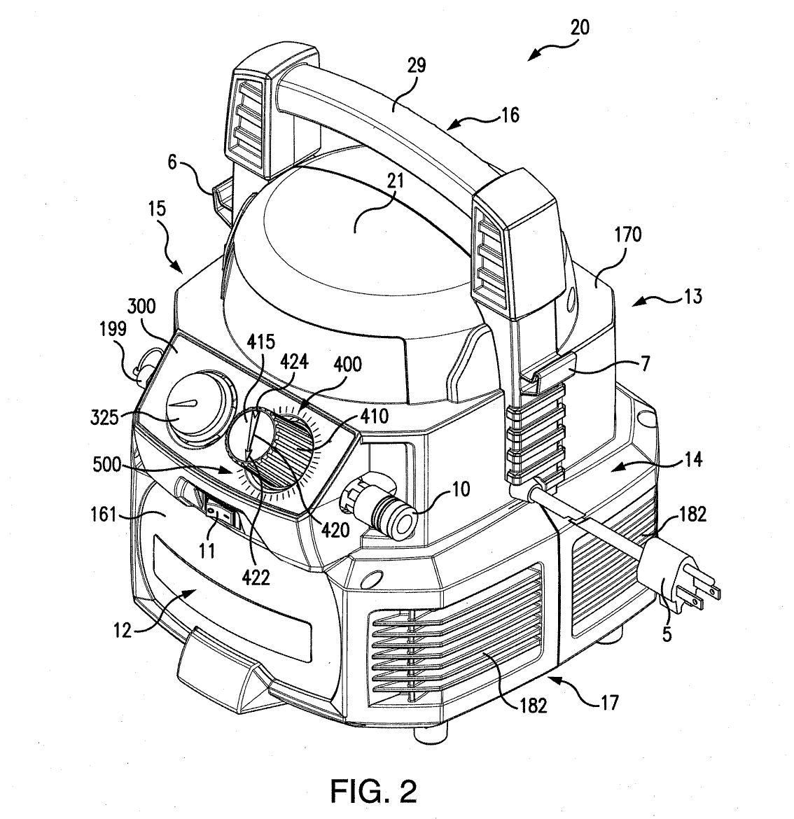

FIG. 2 shows a perspective view of a compressor assembly 20. In an embodiment, the compressor assembly 20 can compress air, or can compress one or more gases, or gas mixtures. The compressor assembly 20 can be portable and can have a handle 29, which optionally can be a portion of compressor body 13.

The definition of “air” herein is intended to be very broad. The term “air” includes breathable air, ambient air, treated air, conditioned air, clean room air, cooled air, heated air, non-flammable oxygen containing gas, filtered air, purified air, contaminated air, air with particulates solids or water, air from bone dry (i.e. 0.00 humidity) air to air which is supersaturated with water, as well as any other type of air present in an environment in which a gas (e.g. air) compressor can be used. It is intended that cooling gases which are not air are encompassed by this disclosure. For non-limiting example, a cooling gas can be nitrogen, can comprise a gas mixture, can comprise nitrogen, can comprise oxygen (in a safe concentration), can comprise carbon dioxide, can comprise one inert gas or a plurality of inert gases, or comprise a mixture of gases.

In an example embodiment, the compressor assembly 20 can have a pressure-setting regulator 400 configured at least in part within a housing 21. The compressor assembly includes a tank pressure gauge 325, a regulator knob 410 and a tool connect member 10 located on a face of the housing 21. An ON/OFF switch 11 can be located on a front portion of the housing 21. The regulator knob 410 is the control which controls the pressure-setting regulator 400 that is set within a desired air outlet pressure guide. The regulator knob 410 that is rotatable to a position that corresponds to the desired air output pressure to the tool. The desired air outlet pressure guide, which can be a scale 500, is located on a dashboard 300 on the face of the housing 21 to be readable by an operator. The outlet pressure guide can optionally be in the form of a label. Alternatively, the outlet pressure guide can be integrally molded with the manifold, or etched thereon. Thereby, the regulator outlet pressure gauge 122 of the prior art shown in FIG. 1 is no longer needed. As a result of the embodiments of the present invention, users can rotate the regulator knob to set the desired outlet pressure, and not have to wait for a pressure gauge to catch up to the regulator set pressure and/or perform back and forth adjustments.

As shown, for example in FIGS. 2, 8, 9 and 10A-D, the scale 500 can be configured to be generally coaxial with the circumference of the regulator knob 410. Such a generally coaxial configuration can allow an indicium of the regulator knob 410, such as set point arrow 420, to be aligned with, or positioned proximate to, a value of outlet pressure on the scale 500. In this embodiment, the regulator knob 410 that has an indicium, such as set point arrow 420, can be turned to align with or point to a desired outlet pressure 550 which by such alignment positively sets that an outlet pressure 550 which is desired, and positively controls and maintains the desired outlet pressure.

FIG. 2 illustrates an example embodiment of the air compressor in which the tool connect member 10 is located on the intake fan side 14 of the housing 21.

In an embodiment, the compressor assembly 20 can have a weight between 15 lbs and 100 lbs. In an embodiment, a portable embodiment of the compressor assembly 20 can have of weight between 10 lbs and 50 lbs, such as 10 lbs to 30 lbs, or 15 lbs to 40 lbs.

In an embodiment, the housing 21 can have a front housing 161 and a rear housing 170 and a plurality of intake ports 182. The compressor assembly can be cooled by air flow provided by a fan 200 the plurality of intake ports 182.

Power can be supplied to a motor 33 of the compressor assembly through a power cord 5 extending through the housing 21. In an embodiment, the compressor assembly 20 can comprise one or more of a cord holder member, such as a first cord wrap 6 and a second cord wrap 7.

In an embodiment, the power switch 11 can be used to change the operating state of the compressor assembly 20 at least from an “on” to an “off” state, and vice versa. In the “on” state, the compressor can be in a compressing state (also herein as a “pumping state”) in which it is compressing air, or a gas, or a plurality of gases, or a gas mixture.

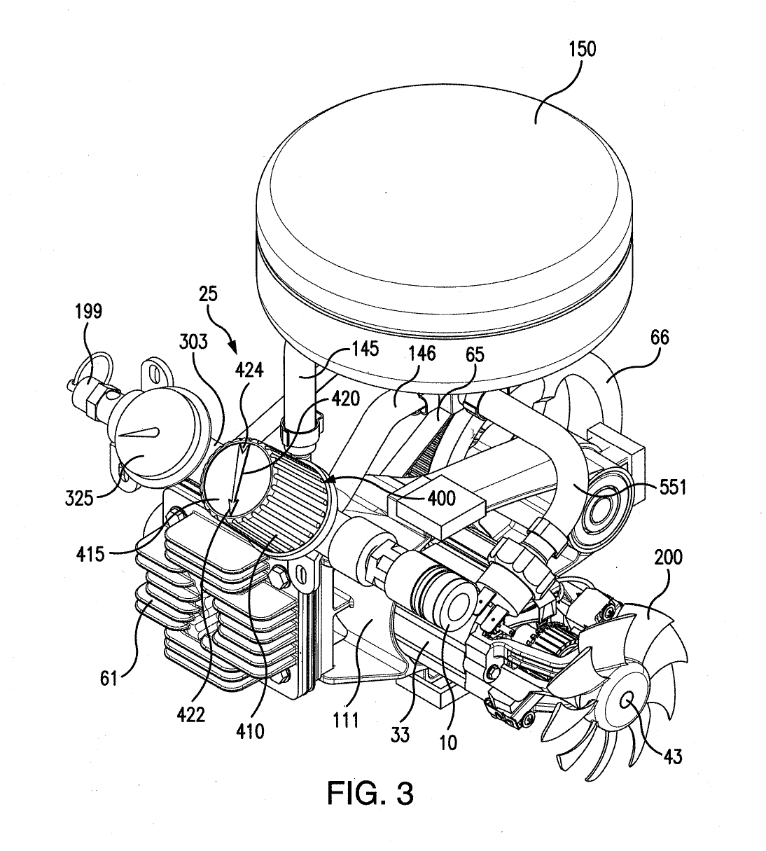

In an embodiment, other operating modes can be engaged by the power switch 11 or a compressor control system, e.g. a standby mode, or a power save mode. In an embodiment, the dashboard 300 can provide an operator-accessible location for connections, gauges and valves which can be connected to a manifold 303 (FIG. 3). In an embodiment, the dashboard 300 can provide an operator access in a non-limiting example to the tool connect member 10, the pressure-setting regulator 400 and the tank pressure gauge 325. In an embodiment, a compressed gas outlet line, hose or other device to receive compressed gas can be connected the tool connect member 10.

A plurality of intake ports 182 can be formed in the housing 21 proximate to the fan 200 and a plurality of exhaust ports 31 (not shown) can be formed in the housing 21 proximate to the pump. The total cross-sectional open area of the intake ports 182. In an embodiment, the cooling gas employed to cool the compressor assembly 20 and its components can be air, which optionally can be taken in from the environment in which the compressor assembly 20 is placed. The cooling gas can be exhausted from the compressor assembly 20 through a plurality of exhaust ports (not shown).

FIG. 3 illustrates the compressor assembly 20 with a portion of the housing 21 removed and showing the internal components of the compressor assembly. The pump assembly 25 compresses a gas, air or gas mixture. In an embodiment, the pump assembly 25 can be powered by the motor 33 (e.g. FIG. 3). The manifold 303 is shown having the pressure-setting regulator 400 and being free of an outlet pressure gauge.

Numeric values and ranges herein, unless otherwise stated, also are intended to have associated with them a tolerance and to account for variances of design and manufacturing, and/or operational and performance fluctuations. Thus, a number disclosed herein is intended to disclose values “about” that number. For example, a value X is also intended to be understood as “about X”. Likewise, a range of Y-Z, is also intended to be understood as within a range of from “about Y-about Z”. Unless otherwise stated, significant digits disclosed for a number are not intended to make the number an exact limiting value. Variance and tolerance, as well as operational or performance fluctuations, are an expected aspect of mechanical design and the numbers disclosed herein are intended to be construed to allow for such factors (in non-limiting e.g., ±10 percent of a given value). This disclosure is to be broadly construed. Likewise, the claims are to be broadly construed in their recitations of numbers and ranges.

The compressed gas tank 150 can operate at a pressure in a range of at least from ambient pressure, e.g. 14.7 psig to 3000 psig (“psig” is the unit lbf/in̂2 gauge), or greater. In an embodiment, the compressed gas tank 150 can operate at 200 psig. In an embodiment, the compressed gas tank 150 can operate at 150 psig.

In an embodiment, the pressure-setting regulator 400 can use a pressure regulating valve. In an embodiment, excess air pressure can be vented to atmosphere through a pressure relief valve 199, such as a spring loaded safety valve. In an embodiment, the pump assembly 25 and the compressed gas tank 150 can be connected to a frame 111 (FIG. 3).

In an embodiment, the compressor has a pressure regulated on/off switch which can stop the pump assembly 25 when a specified compressed gas tank pressure is obtained. Activation of the pump assembly 25 can occur at a pressure in a wide range of set operating pressure, e.g. 25 percent to 99.5 percent of specified compressed gas tank operating pressure. The specified compressed gas tank operating pressure can be in a range from 25 psig to 3000 psig. In an embodiment, the specified compressed gas tank 150 pressure can be 50 psig, 75 psig, 100 psig, 150 psig, 200 psig, 250 psig, 300 psig, 500 psig, 1000 psig, 2000 psig, 3000 psig, or greater than or less than, or a value in between these example numbers.

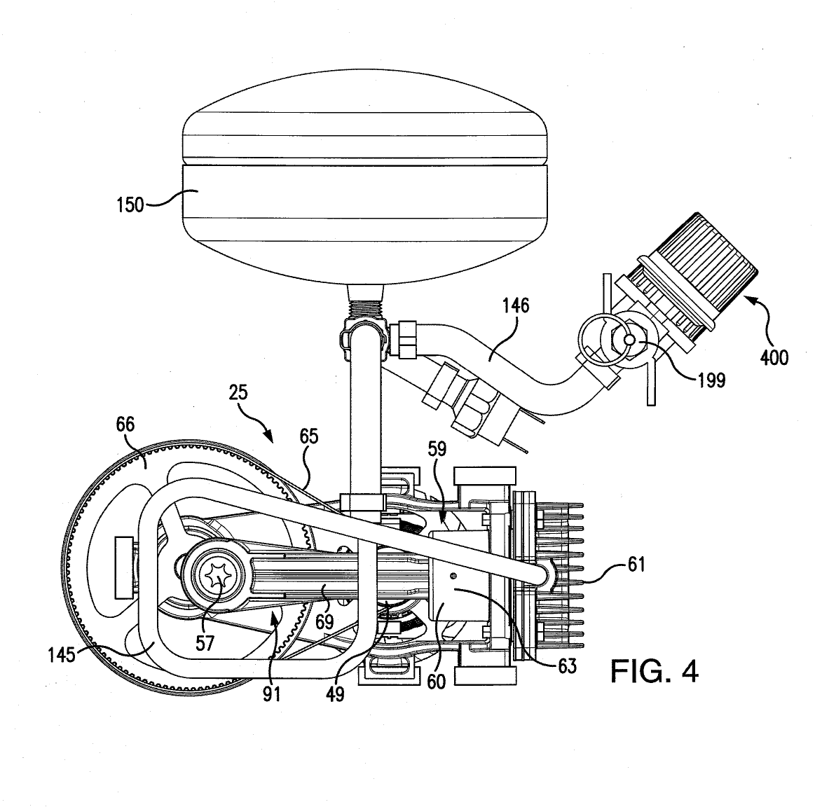

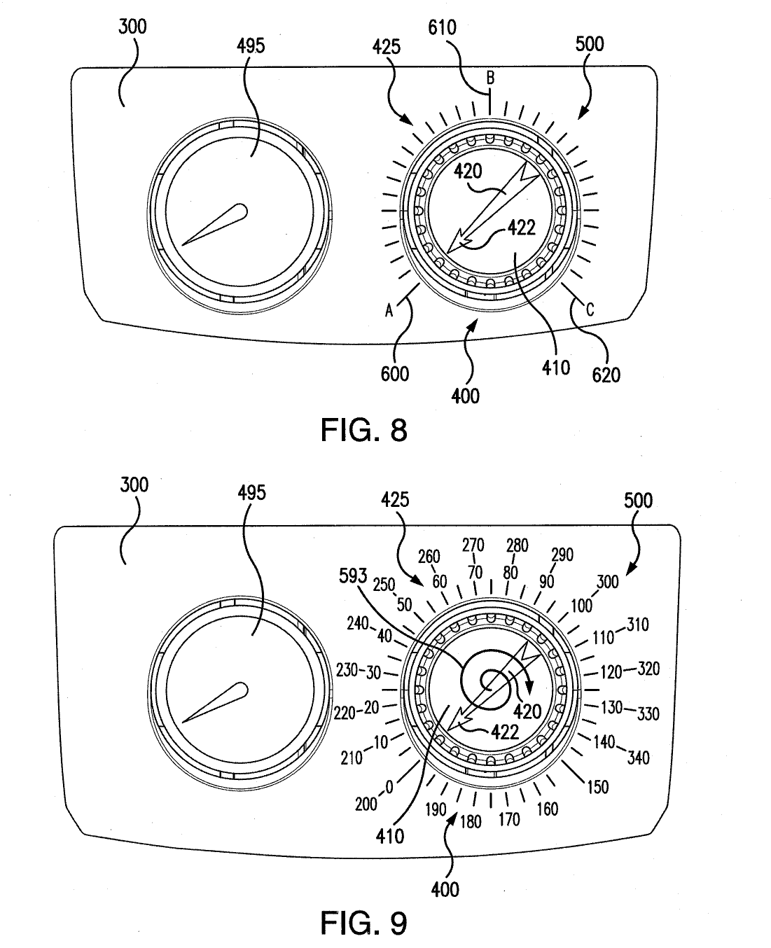

FIG. 4 shows a pump-side view of components of the pump assembly 25. FIG. 4 shows the mechanical design of the compressor assembly 20 having the pressure-setting regulator without the housing 21. In an embodiment, a feed air for compression can be fed to the cylinder head 61 of the pump assembly 25. The feed air can be compressed in a pump cylinder 60 by a piston 63 to produce a compressed gas stream 510 (FIG. 7) from the cylinder head 61 and can pass through a compressed gas outlet line 145 to enter the compressed gas tank 150.

Depending upon the compressed gas output specifications, such as output flow ranges and outlet pressure ranges, of the compressor assembly 20, the motor 33 can operate at a motor speed between 1,000 rpm and 30,000 rpm. In an embodiment, the motor 33 can operate at a speed in a range of between 7,500 rpm and 12,000 rpm. In further embodiments, the motor 33 can operate at e.g. 11,252 rpm, or 11,000 rpm; or 10,000 rpm; or 9,000 rpm; or 7,500 rpm; or 6,000 rpm; or 5,000 rpm.

In an embodiment, the motor can be a non-synchronous universal motor rated, for example, at ½ horsepower, at ¾ horsepower, at 1 horsepower, at 2 horsepower, at 5 horseposer or greater. In an embodiment, the motor can be a synchronous motor. The compressor assembly 20 can accommodate a variety of types of motor 33. The pressure-setting regulator 400 can be used in large-scale industrial equipment and compressors, as well as in portable equipment and compressors.

The pump assembly 25 can have the components which are attached to the motor and/or which serve to compress a gas; which in a non-limiting example can comprise the fan 200, the motor 33, and a pump 59, with a pump arm 91.

The pump assembly 25 can have the pump 59, such as a “gas pump” or an “air pump” that includes a piston 63, a pump cylinder 60, in which a piston 63 reciprocates and a connecting rod 69. The pump further includes a pulley 66, a drive belt 65 and driving mechanism driven by motor 33. The connecting rod 69 can connect to the piston 63 which can move inside of the pump cylinder 60. The motor can be a high speed universal motor, or other type of motor. The piston 63 can compress a gas in the pump cylinder 60 pumping the compressed gas through the valve plate assembly 62 into the cylinder head 61 and then out through a compressed gas outlet port 782 through an outlet line 145 and into the compressed gas tank 150.

The pulley 66 and a sprocket 49, can in part drive the drive belt 65, and can be sized to achieve reduced pump speeds, which can correspond to reciprocation rates and/or a piston speed at which the piston 63 is reciprocated.

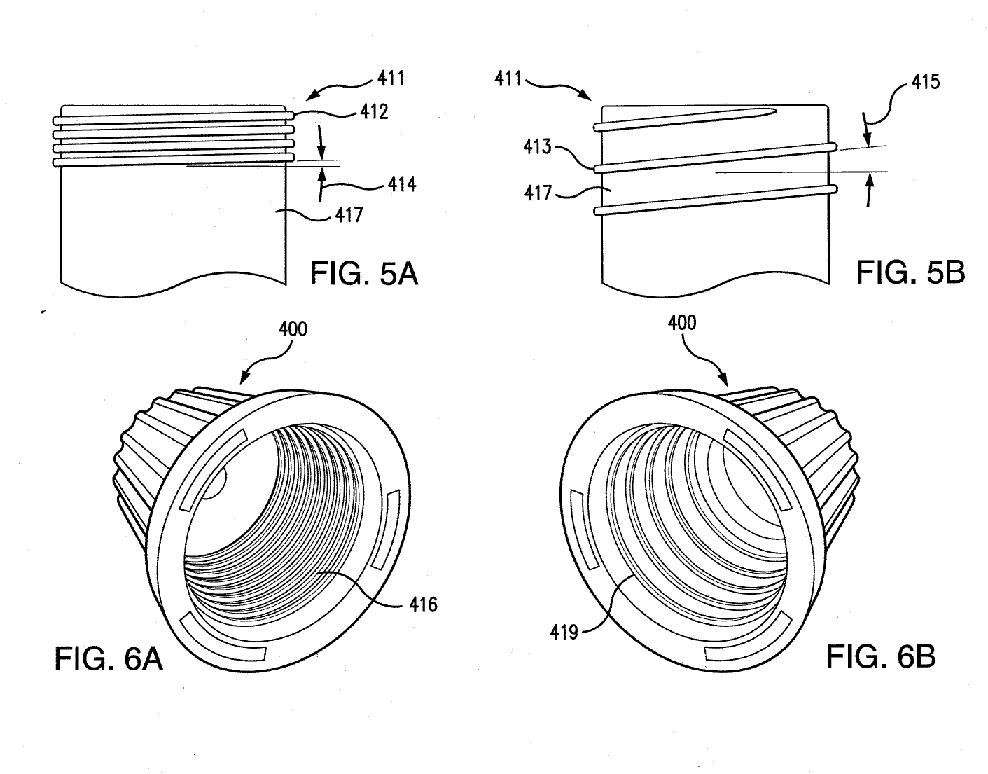

In an embodiment shown in FIG. 5A, a control cylinder 417 of the pressure-setting regulator 400 can have a fine pitch thread 412 and a fine pitch thread angle 414. The fine pitch thread angle 414 can be less than 1.5 degrees, such as 1.17 degrees. In an embodiment, the control cylinder 417 can have greater than 10 threads per inch of the fine pitch thread 412, such as 13 threads per inch. The regulator knob 410 can be a single-turn knob or a multi-turn knob.

FIG. 5B shows the control cylinder with a coarse pitch thread. In an embodiment, the single-turn embodiment, shown in FIG. 5B the control cylinder 417 can have a coarse pitch thread 413 which can have a coarse pitch thread angle 415. The coarse pitch thread angle 415 can be greater than 1.5 degrees, such as 3.79 degrees. In an embodiment, the control cylinder 417 can have fewer than 10 threads per inch of the coarse pitch thread 413, such as 4 threads per inch.

The pitch thread angle, whether the fine pitch thread angle 414, or the coarse pitch thread angle 415 can achieve a desired angle of rotation in which the knob is rotated to achieve a set outlet pressure 550, or to achieve any number of turns or partial turns of a knob to achieve a set outlet pressure 550.

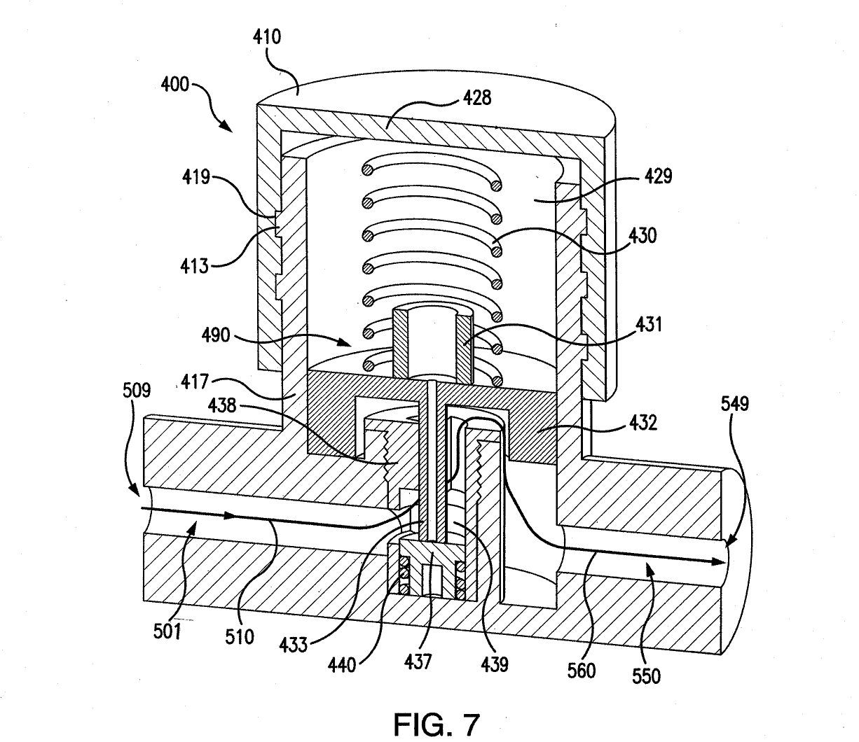

FIG. 6A shows a first example of a regulator knob 410 which has a fine pitch thread grooves 416 corresponding to the fine pitch thread which can engage the fine pitch thread 412 of FIG. 5A. The fine pitch thread groove 416 can have a groove angle and a number of turns to correspond to the fine pitch thread 412 to which it is engaged.

FIG. 6B shows a second example of a regulator knob 410 which has a coarse pitch thread grooves 419 corresponding to the coarse pitch thread which can engage the coarse pitch thread 415 of FIG. 5B. The coarse pitch thread groove 419 can have a groove angle and a number of turns to correspond to the coarse pitch thread 415 to which it is engaged.

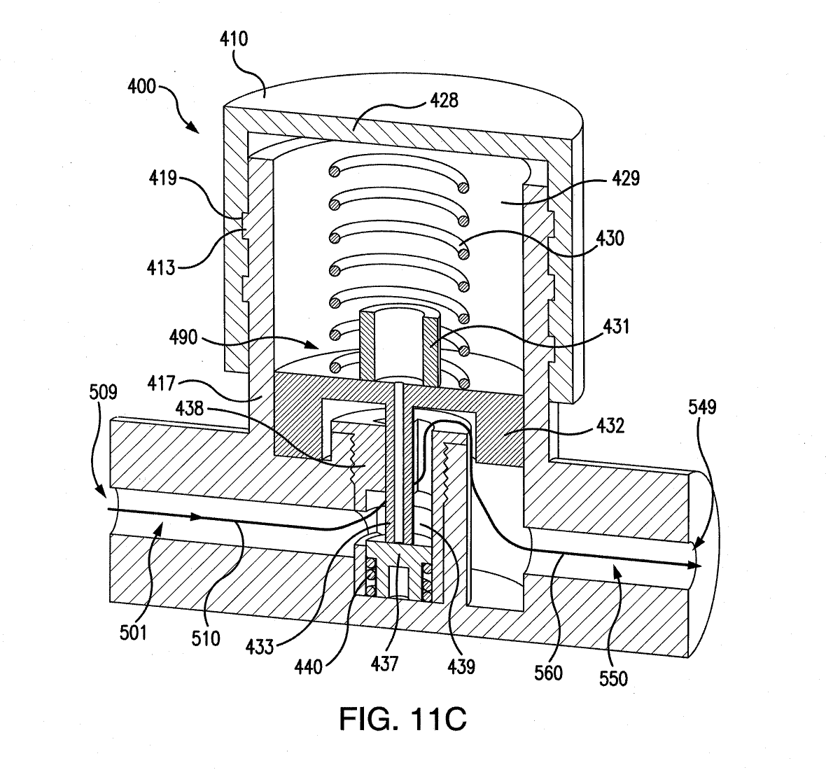

FIG. 7 shows a sectional view of the pressure-setting regulator 400. As shown in FIG. 7, the combined regulator includes a piston 432 that is slideably disposed within the control cylinder 417. The piston 432 moves relative to the control cylinder 417, such as in an up and down motion, when the user rotates the regulator knob 410. For example, the piston 432 can move downward when the user rotates the regulator knob 410 in a clockwise direction to compress the regulator spring 430 thereby increasing the outlet pressure 550 (FIG. 11A). Conversely, the piston moves up when the user rotates the knob in a counterclockwise direction to release the regulator spring 430, raise the piston and reduce the outlet pressure 550.

FIG. 7 shows as an example, the regulator knob 410 having the coarse pitch thread groove 419 rotatably engaged with the coarse pitch threads 413 of the control cylinder 417. A regulator spring 430 can be housed in a spring chamber 429 and can extend between a portion of the knob driver top 428 and a portion of the piston 432. In an embodiment, the regulator spring 430 is held in position at least in part by a spring boss 431.

The regulator spring 430 imparts pressure from the regulator knob 410 to the piston 432. In the example embodiment of FIG. 7, the piston 432 has a valve stem 433 which can project though a valve channel 439. The valve stem 433 can exert pressure on a valve poppet 437 which can be engaged with a valve spring 440.

The pressure-setting regulator 400 regulates the flow of a compressed gas and creates a pressure drop between the compressed gas pressure in the compressed gas tank 150 and/or the manifold 303 and/or the regulator inlet 509, such as inlet pressure 501, and a regulator outlet 549 having the outlet pressure 550. FIG. 7 shows an embodiment in which a compressed gas stream 510 enters a regulator inlet 509 at an inlet pressure 501. The compressed gas stream 510 at an inlet pressure 501 can be blocked by the valve mechanism when it is closed, as shown in FIGS. 11A-11C, or can flow through the valve channel 439 to become an outlet gas stream 560 having an outlet pressure 550 and which exits the pressure-setting regulator 400 through regulator outlet 549.

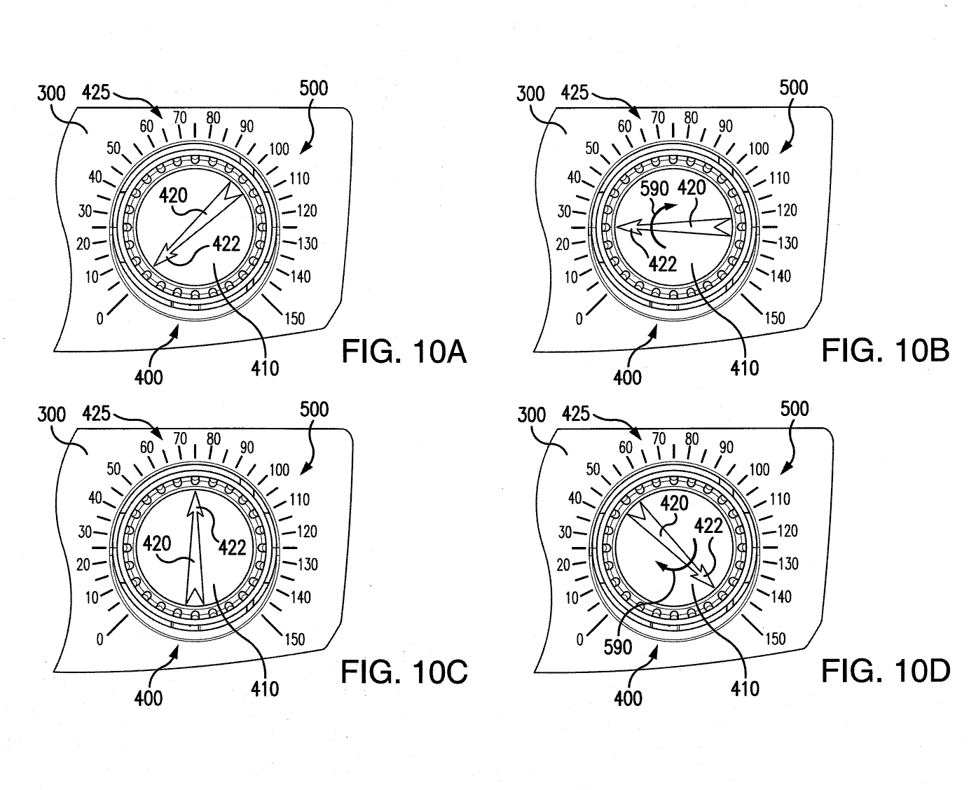

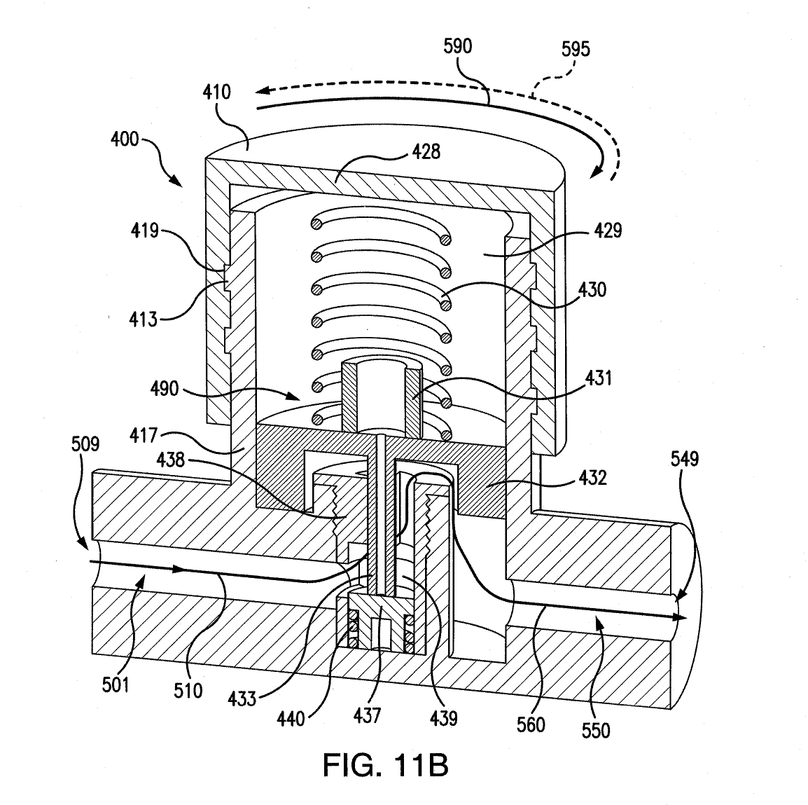

FIG. 8 shows a dashboard 300 having an inlet pressure gauge 495 and the pressure-setting regulator with an example scale of outlet set pressure options. In this example, the letter “A” represents a low set outlet pressure 600, or zero set outlet pressure, point on the scale. The letter “B” represents a midpoint outlet pressure 610. The letter “C” represents a high outlet pressure 620. The low set outlet pressure 600, the midpoint outlet pressure 610 and the high outlet pressure 620 can be set to accommodate a desired pressure range, such as 0 psig to 150 psig (FIG. 10A), or 0 psig to 250 psig, or 0 psig to 300 psig, or 0 psig to 500 psig, or other range.

FIG. 8 also shows the inlet pressure gauge 495 which measures the inlet pressure 501 to the pressure-setting regulator 400.

Optionally, the scale 500 can be set for a single-turn configuration in which a single, or partial, rotation of the regulator knob 410 can be applied to allow a user to select any outlet pressure on the scale 500.

The thread angle and/or number of threads per inch can be set to accommodate a desired range of pressures to achieve a single-turn functionality for a desired range of pressures and/or scale 500.

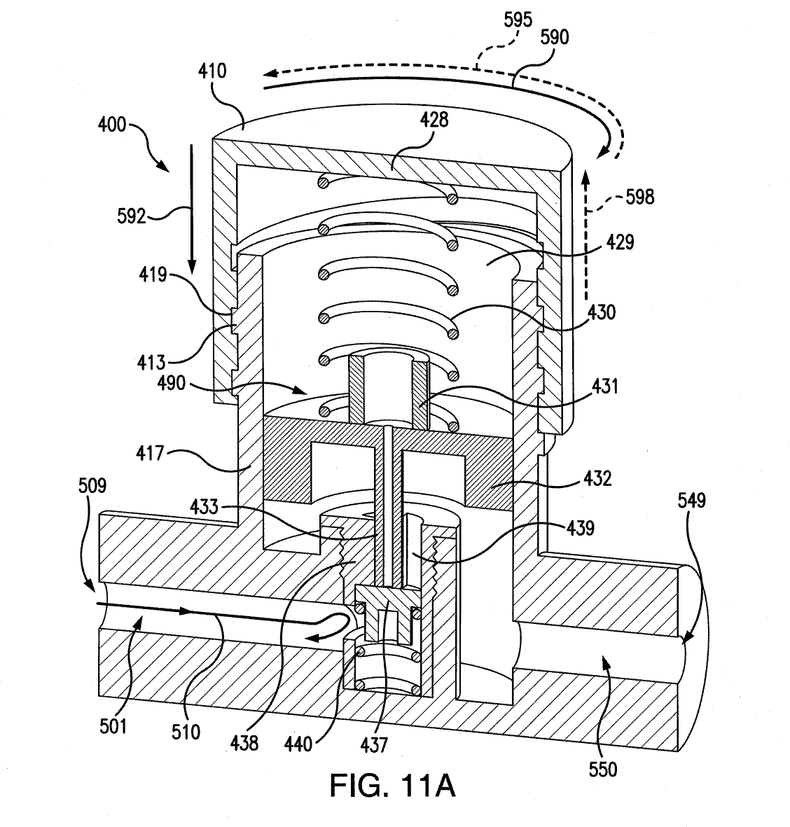

FIG. 9 shows a dashboard 300 having an inlet pressure gauge 495 and a multi-turn configuration of the pressure-setting regulator 400. In a multi-turn configuration, the scale 500 can optionally be configured at different levels concentrically around the regulator knob 410. In a non-limiting example, the scale 500 has two levels concentrically arranged around the regulator knob 410 with the first indicating set outlet pressure values from 0 to 190 psig and the second level indicating set outlet pressure values from 200 psig to 350 psig. As shown by multi-turn increasing flow arrow 593, the regulator knob 410 can be turned greater than 360 degrees, such as 720 degrees to positively control the outlet pressure 550 to the set point value 425 chosen selected by positioning the arrowhead 422 or set point arrow 420 proximate to a selected set point value 425.

In single-turn and multi-turn applications, the regulator knob 410 can be reversibly turned, for example in one direction to increase gas flow and in the reverse direction to decrease gas flow.

FIG. 10A shows the regulator knob 410 bearing an indicium at a first position. The nonlimiting example of FIG. 10A is a single-turn embodiment in which an operator can reversibly rotate the regulator knob 410 to set a desired outlet pressure 550 by aligning the arrowhead 422 of the set point arrow to a set point pressure in the range of the scale 500.

The dashboard 300 of the example of FIG. 10A shows the pressure-setting regulator 400 with a numeric scale of outlet set pressures. Optionally, the scale 500 of the set point values 425 of the outlet pressure is shown on the dashboard 300 and configured concentrically around at least a portion of the regulator knob 410. As shown in FIG. 8 and the series of FIGS. 10A-10D, the regulator knob 410 can be rotated to select the set point value 425 of outlet pressure 550 by aligning the arrowhead 422 proximate to the set point value 425 selected by an operator at the outlet pressure 550 desired.

In the embodiment of FIG. 10A, the regulator knob 410 is a single-turn knob which can be smoothly rotated to select any value whether marked on the scale or between markings between a minimum outlet pressure value and a maximum outlet pressure value, which for example can between 0 psig to 150 psig, or other range as desired.

In FIG. 10A, the pressure-setting regulator 400 is in a “no flow” position in which the set point value is zero, the outlet gas stream 560 is zero, and the outlet pressure 550 not affected by the inlet pressure 501. When the pressure-setting regulator 400 does not allow flow, the outlet pressure 550 can be ambient as no flow is passing through the pressure-setting regulator 400. In this example, the zero pressure setting is the low point of the pressure range of the scale 500. The configuration is shown, for example, in FIGS. 10A-10D.

The scale 500 shown in FIG. 10A indicates set point values of outlet pressure 550 from 0 psig to 150 psig. By rotating the regulator knob 410 any value between 0 psig to 150 psig can be set at the outlet pressure 550 by the positive manual control of the operator turning the knob to select a given set point value 425 of outlet pressure 550 by aligning the arrowhead 422 proximate to the set point value 425 selected.

In an embodiment, the pressure-setting regulator 400 can be calibrated for exacting performance in achieving and maintaining a set outlet pressure 550. A calibrated pressure gauge can be attached to a test manifold having an attached uncalibrated pressure-setting regulator. The uncalibrated pressure-setting regulator 400 can be set to a mid-range outlet pressure, such as 100 psig in a non-limiting example. In a calibration step, when the uncalibrated pressure-setting regulator 400 is set to a mid-range outlet pressure, an indicium, such as a label bearing a set point arrow 420, can be placed on the knob driver top 428 (FIG. 10A) having the arrowhead 422 pointing to the mid-range outlet pressure, such as 100 psig, resulting in a calibrated pressure-setting regulator 400 calibrated to the mid-range outlet pressure.

In an embodiment, the mid-range outlet pressure can occur at a one-half of the rotational range of the regulator knob, and the scale can be configured to have the mid-range outlet pressure value positioned at the point of one-half of the rotation al range of the regulator knob. This allows the indicium to be configured on the regulator knob such that at the point in which the one-half of the rotational range of the regulator knob the indicium is aligned with, or is proximate to, the mid-range outlet pressure value of the scale, for example an arrowhead 422 pointing to the mid-range outlet pressure value of the scale.

FIG. 10B shows the knob bearing an indicium being rotated to a second position. FIG. 10B shows the regulator knob 410 being turned in the increasing flow direction 590 to select an outlet pressure set point 425 of 25 psig. When rotated to the second position, the valve configuration of pressure-setting regulator 400 is open to achieve an outlet gas stream 560 flow having the outlet pressure 550 of 25 psig. The configuration having a flow of the outlet gas stream 560 is shown, for example, in FIGS. 11A-11C.

FIG. 10C shows the regulator knob 410 having a set point arrow 420 at a third position. FIG. 10C shows the knob positively controlling the outlet pressing 550 to the set point value 425 of 75 psig. FIG. 10C shows the pressure-setting regulator 400 maintaining the outlet pressure 550 at 75 psig. In the example of FIG. 10C, the 75 psig value is the mid-range set point of outlet pressure 550 of the pressure range of the scale 500.

FIG. 10D shows the knob bearing an indicium, such as set point arrow 420, being rotated to a fourth position in the increasing flow direction 590 to select an outlet pressure set point 425 of 150 psig, which is the maximum outlet pressure shown in the example of FIG. 10D. The valve configuration of pressure-setting regulator 400 opens to achieve an outlet gas stream 560 flow having the outlet pressure 550 of 150 psig. In this example, the 150 psig value is the high end set point of outlet pressure 550 of the pressure range of the scale 500.

Optionally, the high-end set point of outlet pressure 550 of the scale 500 can be a maximum output pressure possible from the compressor. In another embodiment, the high-end set point of outlet pressure of the scale 500 can be limited to less than the maximum outlet pressure from the compressor. The limit on the outlet pressure 550 can be achieved by the design of the control knob threads or the knob thread grooves. Alternately, the compressor can be mechanically limited to the high-end set point of outlet pressure 550 of the scale 500.

The rotation of the regulator knob 410 is reversible and the regulator knob 410 can be turned in either the increasing flow direction 590, or the decreasing flow direction 595 (FIG. 11A), at an operator's discretion. Thus, an operator can change the outlet pressure 550 from a selected value to a different value by rotating the knob in either the increasing flow direction 590 or the decreasing flow direction 595.

In an example the regulator knob 410 can be rotated from a set pressure, such as 150 psig, by rotating the regulator knob 410 in the decreasing flow direction 595 to the first position in which the pressure-setting regulator 400 is in an “no flow” position in which the set point value is zero, the outlet gas stream 560 is zero.

FIG. 11A shows a sectional view of the pressure-setting regulator 400 in a closed configuration. In the example of FIG. 11A, the pressure-setting regulator 400 is in a “no flow” position (FIG. 10A) in which the set point value is zero, the flow of the outlet gas stream 560 is zero, and the outlet pressure 550 not affected by the inlet pressure 501. As shown in FIG. 11A, the regulator knob 410 is configured such that the valve poppet 437 is seated in poppet seat 438 and the valve configuration is closed and does not allow any portion of compressor gas stream to pass.

In an embodiment, the pressure-setting regulator 400 can be self-relieving and can respond to maintain a constant set outlet pressure when the set pressure is changed from a higher set outlet pressure to a lower set outlet pressure. In another example, the pressure-setting regulator 400 can be non-relieving. However, in the non-relieving embodiment the outlet pressure will reset from a higher outlet pressure to a lower outlet pressure after turning the regulator knob to set the lower outlet pressure and once the residual higher pressure gas is released from the valve channel 439 by use of a tool or other means. In either the relieving or non-relieving embodiments, the pressure-setting regulator valve configuration will respond to maintain a constant outlet pressure as compressed gas is used.

In the embodiment of FIG. 11A, rotating the regulator knob 410 in the increasing flow direction 590 can tighten the regulator knob 410 in a tightening direction 592. In the reverse, as shown by dashed line type, rotating the regulator knob 410 in the decreasing flow direction 595 can loosen the regulator knob 410 in the loosening direction 598.

FIG. 11B shows a sectional view of the pressure-setting regulator 400 having the knob rotated to increase the pressure of an outlet gas stream. When the regulator knob 410 is rotated in an increasing flow direction 590 the poppet 437 is moved away from the poppet seat 438. As a result, flow from compressed gas stream 510 is allowed to flow through the valve channel 439 to become an outlet gas stream 560. The outlet gas stream 560 has a pressure which is positively controlled to achieve a set point value 425 of outlet pressure 550. For example, the rotation of the regulator knob 410, as shown for example in each of FIGS. 10A-10D, can move the poppet 437 away from the poppet seat 438 and allow flow from compressed gas stream 510 to flow through the valve channel 439 to become an outlet gas stream 560 having a pressure which is positively controlled to achieve a set point value 425 of the outlet pressure 550. In the example of FIG. 11B moving the poppet 437 away from the poppet seat 438 decreases the pressure drop across the valve 490, increases the flow rate, and increases the outlet pressure 550.

FIG. 11B shows that from a set position of the regulator knob 410 which maintains the flow at the set outlet pressure 550 can be manually rotated in the increasing flow direction 590, or the decreasing flow direction 595, shown as a dashed arrow, at an operator's discretion. The regulator knob 410 can be manually rotated in the increasing flow direction 590 to any outlet pressure 550 from a minimum value to a maximum value, or any outlet pressure 550 in between these set points. The regulator knob 410 can also be manually rotated in the decreasing flow direction 595 to any outlet pressure 550 from a maximum value to a minimum value or any outlet pressure 550 in between these set points.

When the regulator knob 410 is rotated in the decreasing flow direction 595, the pressure of an outlet gas stream which is flowing is also reduced. When the regulator knob 410 is rotated in decreasing flow direction 595, poppet 437 is moved toward poppet seat 438 and the flow rate from compressed gas stream 510 through the valve channel 439 is decreased, and the flow rate which becomes outlet gas stream 560 is also decreased. When the regulator knob 410 is rotated in decreasing flow direction 595, for example in the counterclockwise direction, the poppet 437 is moved toward poppet seat 438 which increases the pressure drop across the valve 490, decreases the flow rate and decreases the outlet pressure 550 during flow.

FIG. 11C shows a sectional view of the pressure-setting regulator having the knob rotated to a set outlet pressure 550 and regulating the flow of an outlet gas stream. FIG. 11C shows the pressure-setting regulator 400 maintaining the set point value 425 of outlet pressure 550, such as shown for example in FIG. 10C.

From any set outlet pressure, the pressure-setting regulator 400 can be rotated in the decreasing flow direction 595 to a “no flow” position (as shown in FIG. 10A), and the flow of the outlet gas stream 560 can be reduced to zero. When the regulator knob 410 is rotated to a “no flow” position the valve poppet 437 to be seated in poppet seat 438 (FIG. 11A) and the valve configuration can be closed not allowing any portion of compressor gas stream to pass.

The scope of this disclosure is to be broadly construed. It is intended that this disclosure disclose equivalents, means, systems and methods to achieve the devices, designs, operations, control systems, controls, activities, mechanical actions, fluid dynamics and results disclosed herein. For each mechanical element or mechanism disclosed, it is intended that this disclosure also encompasses within the scope of its disclosure and teaches equivalents, means, systems and methods for practicing the many aspects, mechanisms and devices disclosed herein. Additionally, this disclosure regards a pressure regulator and its many aspects, features and elements. Such an apparatus can be dynamic in its use and operation. This disclosure is intended to encompass the equivalents, means, systems and methods of the use of the compressor assembly and its many aspects consistent with the description and spirit of the apparatus, means, methods, functions and operations disclosed herein. The claims of this application are likewise to be broadly construed.

The description of the inventions herein in their many embodiments is merely exemplary in nature and, thus, variations that do not depart from the gist of the invention are intended to be within the scope of the invention and the disclosure herein. Such variations are not to be regarded as a departure from the spirit and scope of the invention.

It will be appreciated that various modifications and changes can be made to the above described embodiments of the compressor assembly as disclosed herein without departing from the spirit and the scope of the following claims.

We claim:

1. A pressure regulator, comprising:
a scale indicating a plurality of outlet pressures which can be set as a selected outlet pressure of a gas exiting the pressure regulator;
a regulator knob adapted to be manually rotated to a selected outlet pressure from the plurality of outlet pressures; and
a regulator spring that at least in part controls a valve that regulates a flow of said gas,
wherein the regulator knob is adapted to change a spring compression of the regulator spring when the regulator knob is manually rotated to set the selected outlet pressure of the gas.

2. The pressure regulator of claim 1, wherein rotation of the regulator knob to the selected outlet pressure is free of a feedback control mechanism.

3. The pressure regulator of claim 1, wherein the selected outlet pressure is set by the regulator knob to a value selected on the scale, the pressure regulator being configured to produce an outlet pressure free of reference to an outlet pressure gauge.

4. The pressure regulator of claim 1, wherein the scale is configured to be generally coaxial with the circumference of the regulator knob.

5. The pressure regulator of claim 1, wherein the scale is configured to be generally coaxial with the circumference of the regulator knob and indicates a plurality of outlet pressures which can be selected and which have one or more of the plurality of outlet pressures in a range of from 25 psig to 250 psig.

6. The pressure regulator of claim 1, wherein the regulator knob has single-turn coarse grooves which slideably engage single-turn coarse threads which project from a portion of a regulator body.

7. The pressure regulator of claim 1, wherein the regulator knob further comprises an indicium which can be aligned with a portion of the scale to set the selected outlet pressure.

8. The pressure regulator of claim 1, wherein the regulator knob further comprises an arrow which can be pointed to a pressure indicated by the scale to set a selected outlet pressure.

9. The pressure regulator of claim 1, wherein the regulator knob can be ratcheted when rotated to cause an alignment of a portion of the regulator knob to a portion of the scale to set the selected outlet pressure.

10. A pressure control system, comprising:
a pressure regulator which has a regulator knob which can be rotated to control an outlet pressure of a gas exiting the pressure regulator;
a scale configured proximate to the regulator knob and indicating a plurality of outlet pressure values one of which can be selected as an outlet set pressure; and
an indicium mounted on and moved by the regulator knob, the indicium proximate to an outlet pressure value that is selected as an outlet set pressure,
wherein selection of the outlet set pressure by rotating the regulator knob controls the outlet pressure of the gas exiting the regulator at the outlet set pressure.

11. The pressure control system according to claim 10, further comprising a control cylinder having a single-turn course thread projecting therefrom, the single-turn course thread configured to slideably engage the regulator knob.

12. The pressure control system according to claim 10, wherein the regulator knob is a single-turn regulator knob.

13. The pressure control system according to claim 10, wherein the outlet pressure is controlled to within 15 percent of an outlet set pressure when the regulator knob remains in a fixed position corresponding to a selected outlet pressure.

14. The pressure control system according to claim 10, wherein the indicium which is configured to indicate an outlet pressure midpoint when the regulator knob is rotated to a point at about one-half of its rotational range.

15. A compressor for producing a compressed gas, comprising:
a pressure regulator;
a scale indicating a plurality of outlet pressures which can be set as a selected outlet pressure of a gas exiting the regulator;
a regulator knob adapted to be manually rotated to set the selected outlet pressure from the plurality of outlet pressures of the scale; and
a regulator spring that at least in part controls a valve that regulates a flow of said gas;
wherein the regulator knob is adapted to change a spring compression of the regulator spring when the regulator knob is manually rotated to set the selected outlet pressure of the gas, and
wherein the scale is configured proximate to a regulator knob.
